(19) United States
(12) Patent Application Publication
(10) Pub. No.: US 2021/0346735 A1
(43) Pub. Date: Nov. 11, 2021

(54) Fine Cover for a Respirator Mask

(71) Applicant: Brian Michael Coyle, Canyon, CA (US)

(72) Inventors: Brian Michael Coyle, Canyon, CA (US); Alys Larson, Canyon, CA (US)

(21) Appl. No.: 17/210,504

(22) Filed: Mar. 24, 2021

Related U.S. Application Data
(60) Provisional application No. 63/030,925, filed on May 28, 2020.

(51) Int. Cl. A62B 23/02; A41D 31/14; A41D 13/11; A62B 18/08

(52) U.S. Cl. CPC A62B 23/025; A62B 18/08; A41D 13/1107; A41D 31/145

(57) ABSTRACT

A fine cover particularly for use with respirator facemasks comprises one or more components, each defined by a perimeter, holding flexible, breathable material. The components expand to cover part of a respirator facemask and fold smoothly to close exposed surfaces during removal, thereby preventing pathogen shedding. The cInstitute of Medicine, 2006 Reusability of Facemasks During an Influenza Pandemic: Facing the Flu; losed unit is placed in a bag for cleaning, disposal, or testing. Samples taken from fine cover can be tested to detect airborne pathogens, an optimal airborne pathogen monitoring system in medical facilities. In addition, the fine cover may have graphical imagery to directs an observer's gaze in the same patterns followed when looking at an unmasked face, thereby reducing subconscious interaction anxiety.

### CROSS-REFERENCE TO RELATED APPLICATIONS

The present Application claims the benefit of U.S. Provisional Patent Application No. 63/030,925 filed May 28, 2020 and titled “Anti-Transmissive Cover for Mask”, the contents of which are incorporated in this disclosure by reference in their entirety. The present Application also claims the benefit of U.S. Provisional Patent Application No. 62/993,705 on Mar. 24, 2020 and titled “Anti-Pathogen Mask Shield”, the contents of which are incorporated in this disclosure by reference in their entirety.

### BACKGROUND OF THE INVENTION

Commonly used face masks are either absorbent, to prevent the wearer from transmitting pathogens, or contaminant-impermeable, to prevent pathogens reaching the wearer's respiratory system. A contaminant-impermeable face mask is preferably made of materials like nonwoven polymers, with “electret” charges that capture very small (<1 microns (μm)) particles in its matrix. A contaminant-impermeable face mask is generally labeled by its filtration efficiency for particles >0.3 μm, such as “N95,” which refers to a 95% barrier level. In the U.S.A. such masks are classified by the National Institute for Occupational Safety and Health. In Japan such masks are classified by the Japan Ministry of Health, Labour, and Welfare. Hereafter such a contaminant-impermeable mask will be referred to as a “respirator mask.” It is sometimes necessary to reuse respirator masks, as they may have limited availability. To clean a respirator mask between use may require transport, potentially spreading the polluted mask's adhered pathogens. Removal of a respirator mask, or merely jostling it, can dislodge adhered pathogens.

Respirator mask material intercepts pathogenic microbes. They adhere to its surface, but survive, according to research compiled by the U.S. National Academy of Science Institute of Medicine (IoM), and research by Liu et al. for the virus SARS CoV-2 (Institute of Medicine, 2006 1; Lui et al., 2020, 2.) Healthcare workers are aware respirator masks risk nosocomial transmission when jostled or doffed, according to research carried out after the SARS CoV-1 pandemic (The SARS Commission, 2006, 3.)

Electret charge is critical to respirator mask success, because fibers are too far apart to intercept sub-micron particles on their own. The electret traps both aerosol and virus.

Research into respirator mask reuse examined various cleaning methods: heat, steam, hydrogen peroxide, etc. These generally remove microbial residue without damaging mask structure. However a study to examine cleaning impacts on electret charge found it diminished significantly under all conditions examined (Hossain, E., et al., 2020, 4.)

Respiratory pathogens such as SARS CoV-2 spread through aerosols. An infected person exhales virions on liquid droplets, generally 10-100 82 m. Gravity captures these. But microscopic sphere surface area to mass is enormous, causing rapid evaporation. An aerosol shrinks from 25 μm to 5 μm in under 0.05 seconds. Before the droplet descends a few centimeters, gravity ceases to dominate movement, and air currents move it (Wells, W. F., 1955, 5.)

Inhaling airflow entrains 5μm particles at 2 to 20 m/s (Ogden, T. L. & J. L. Birkett, J. L., 1978, 6.) Respirator masks intercept them. Some adhere to mask surfaces (Chin, A. W. H., et al., 2020, 7.) When respirator masks shake or are doffed, they may shed (Blachere F. M., et al., 2018, 8.)

Many users of respirator masks complain they cause discomfort. The U.S. Department of Veterans Affairs found healthcare workers inappropriately use absorbent masks instead of respirator masks, or don and doff the respirator mask inappropriately, because of discomfort and intolerance (Department of Veterans Affairs, 2012, 9.) A review of the response of healthcare workers to a pandemic found that wearing a mask was the precaution most frequently cited as bothersome, and the most commonly cited difficulty with masks was physical discomfort (Nickell, L., et al., 2004, 10.) Another survey found the principal cause of respirator mask discomfort is high face temperature (Baig, A. S., et al., 2010, 11.)

IoM recommends healthcare workers use absorbent face masks as covers for respirator masks, to prevent pathogen build-up on the respirator mask. Wearing an absorbent face mask on top of a respirator mask aggravates discomfort. Absorbent face masks completely cover the user's lower face. This makes them larger than necessary for protecting a respirator mask. Absorbent face masks incorporate multiple layers. This makes absorbent face masks heavier and bulkier than necessary for covering a respirator mask. Absorbent face masks worn on top of a respirator mask are awkward to remove, increasing transmission potential. Absorbent face masks worn on top of a respirator mask do not fit properly, causing an unattractive appearance.

Because a respirator mask intercepts airborne pathogens entrained on air currents generated by the wearer's breathing, they are concentrated in the respirator mask's center-front area, over the wearer's nostrils and mouth.

Respirator mask discomfort (primarily heat-related) limits use in situations where they are needed. Limited respirator mask supply forces their reuse, but respirator mask cleaning reduces electret charge, and pathogens collect on respirator mask surfaces, making reuse risky. Doffing respirator masks used in high transmission conditions risks pathogen shedding and nosocomial spread. respirator mask surfaces increase interaction anxiety.

Medical facilities lack biosensor capacities. Computing Devices Canada, a General Dynamics subsidiary, is an industry leader in military biological detectors. In 2001 they recognized that much lower cost and power, reduced weight and size, and easier to cool real-time monitoring of airborne biological disease-causing agents was needed in hospitals (TRW, 2001, 12.) It should be fast, reliable, specific, and inexpensive. Although these needs have been “recognized for at least two decades, no one device has yet been shown to have all of these desirable traits simultaneously” (DeFreez, R., 2009, 13.)

U.S. Centers for Disease Control [CDC] has funded a national laboratory system based in hospitals, to enhance airborne pathogen early detection. As the CDC has limited resources “solutions would necessarily build upon the existing infrastructure and systems”(Astles, J. R., et al., 2010, 14.) There is a disconnect between high-tech airborne sensor deployment, which costs thousands of dollars per instrument, and engaging hospital laboratories with existing technology for fluid detection. Instead of buying pathogen detector systems that imitate smoke alarms, hospitals can use existing systems. Mask wearers entrain microbial particles when they inhale; the center-front area of masks intercept airborne pathogens, which adhere there. If a secondary surface was placed over this central area, capable of absorbing/adsorbing pathogens, it could be preserved, and a sample of its rinse analyzed in hospital laboratories using existing methods. The cost would be minimal, and capitalize on existing infrastructure

An air-exchange opening is inserted at the center-front area of some respirator masks. If the wearer sheds microbial pathogens, they can pass through the air exchange mechanism. A fine-cover system is needed to cover the air exchange opening, to intercept exhaled pathogens without diminishing breathability.

What is needed is a system that addresses respirator mask heat discomfort that limits use; that makes respirator mask cleaning (which reduces effectiveness) unnecessary; that prevents nosocomial transmission when respirator masks are moved or removed; that reduces respirator mask-induced social anxiety; that prevents respirator mask wearers transmitting through respirators; and that can serve as a low-cost biosensor in medical facilities.

U.S. Pat. 5,496,507 to Angadjiv et al. (P1) teaches a method of treating nonwoven microfibers to provide them with electret charge to filter particulate matter. Claim 1 specifies that this requires high pressure water jets, and claim 4 further explains the pressure must be between 69 kPa to 3450 kPa (1,441 lbf/ft² to 72,053 lbf/ft² of force.) This exceeds the capacity of an ordinary medical institution, so cannot address the “loss of charge” problem that results from mask cleaning.

U.S. Pat. 8,783,253 to Flaherty (P2) is a decorative cover for a respirator mask, for wearer fashion, and to reduce intimidation of patients in health care settings. The device has a panel of non-filtering fabric material, and fasteners attach it to the underlying mask. According to claim 1, the panel substantially covers the respirator mask; claim 2 states the panel has a design to improve appearance.

'253 does not reduce the most significant discomfort problem of respirator masks, namely heat build-up. '253 claims to avoid adding discomfort, by using highly permeable fabric that allows “relatively small particles and the like to pass through” (col 2, line 66.) This prevents '253 from preserving the underlying mask, or serving as a sensor to detect airborne pathogens,

'253 has the same “convex shape of the respirator mask” underneath (col 3 line 19.) It does not address problems identified with respirator masks, such as pathogen shedding from their surface. Respirator facemask convex shapes impose inertial forces that cause deformation energy to propagate across their surfaces when they are removed. The use of convex shape in '253 imposes the same problem. The use of fasteners to attach '253 to the underlying respirator mask introduces a new source of friction and vibration to cause pathogen shedding. '253 does not show how decorative features alter observer response. Humans spend more time looking at faces than any other object. They have habitual eye movement patterns. Respirator facemasks interfere with these, increasing observer anxiety. Merely putting decoration on the facemask surface does not recreate a sequence of attractive points that can guide eye movements in a familiar pattern. Decoration can interfere with interaction, interposing images that distract observers from the wearer's expressions.

U.S. Pat. Application 2009/0,014,006 by Levin (P3) discloses a peel-and-stick cover for a surgical mask. It's purpose is to provide a decorative appearance. Called “Novelty mask cover,” it does not describe how the image will modify perception of the wearer, only that it will relieve the onus of ordinary “ugly masks” worn in medical settings [0005]. As with '253, mere decorations do not render the wearer less imposing or distant. As '006 offers no other purpose or structural detail, it solves none of five problems or one requirement addressed by this invention.

2015/0,034,098 by Schumacher (P4) is a mask device with a filter holder in which a replaceable air filter can be attached. The “slope and shape” of the filter is supposed to reduce air transmission to maximize “efficiency of particle removal,” which lacks scientific reference or justification. The filter can be detached so wearers can access their nose and mouth. The filter may be decorated with images. Discounting the filtration claims which have no apparent basis, '098's primary purpose is to provide a mask with a removable middle part, the middle part also being decorated. This does not address any of the problems and requirement solved by this invention.

The present invention is a pragmatic, original, “out-of-the-box” solution to problems identified by IoM, CDC, and many healthcare workers. It accepts reality: healthcare workers continue to underuse respirator masks due to discomfort. They will not follow IoM recommendations intended to reduce nosocomial transmission, because wearing a second mask aggravates discomfort. They do not want to wear decorative masks that are silly or distracting, but do not like the limits mask impose on interpersonal interaction. The CDC's goal of airborne pathogen detection will not be easily achieved with expensive independent collection monitors.

This invention reduces discomfort by reflecting heat. It is scaled to intercept a large fraction of pathogens, so it covers a fraction of the respirator mask. The invention does not shed pathogens when removed, because its structure does not cause deformation energy to jiggle its surface upon removal. The invention has imagery that attracts observers such that their eye movements follow habitual patterns used when looking at an unmasked face. Instead of expensive collectors, the invention provides a platform for pathogen collection, since human breath entrains small particles. They can be conveniently and inexpensively tested in medical facilities where they're used, or even frozen for shipment elsewhere.

### SUMMARY OF THE INVENTION

The present invention provides a fine-cover system to place on a respirator mask, of disposable or reusable breathable material in components, that includes a method to reduce the respirator mask wearer's facial temperature, that protects and extends the use of the respirator mask, that is removed without adhered pathogens dislodging, that when removed seals the fine-cover surfaces, and that can be sampled and tested in medical laboratories for pathogen presence. Alternatively, the present invention provides the public with a useful alternative to known devices or methods current used to cover respirator masks. The present invention may include visual features that alter perception of the wearer's face. The present invention may include flexible material that has antiviral agents incorporated.

This invention will permit healthcare workers to conveniently and safely reduce nosocomial transmission, and allow healthcare workers and healthcare institutions to meet scientific consensus goals at limited expense, using existing infrastructure.

According to one embodiment, there is provided a fine-covering system for a respirator mask that reduces mask wearer discomfort by a) incorporating lightweight, breathable material, including heat reflective material, in a plurality of components, each with a perimeter, and b) limiting the fine-covering system to certain regions of the underlying respirator mask, and the embodiment reduces pollution of the underlying respirator mask by c) intercepting respiratory pathogens with the material and preventing adhered pathogens detaching by d) configuring the components to prevent spreading energy deformation when doffing the fine-covering system, and e) securing the fine-covering system after use by inserting the folded, sealed components in a transport bag for cleaning, disposal, or testing, and where the fine-covering system when in use is held over the respirator mask with elastic bands, and as elastic bands when released accelerate any attached object, the fine-covering system isolates the material in each component and isolates each component from other components to prevent energy deformation transmission between components, where each component connects to another component across a perimeter, where the outermost component folds, rotates, or contracts across another component when removing.

According to one embodiment of the present invention, there is provided another fine-covering system for a respirator mask that, in the case where the respirator mask has an air exchange valve, a) has a component that covers the area of the air exchange valve, in order to b) intercept exhaled pathogens with a fabric material to which pathogens adhere, and c) attaches the fabric material to one or more perimeter structures that completely surround the air exchange valve and compress radially against the respirator mask, and d) configuring the attachment of the fabric material to the perimeter to prevent energy deformation spreading from the perimeter to the fabric material, and e) sealing the resulting interspace gap between the air exchange valve and the fabric material by the compression of the one or more perimeter structures, and where energy deformation does not detach pathogens in the fabric material because of the significantly different mechanical properties of the perimeter and the fabric material. When the fine-cover is worn, the perimeter tension increases the volume of the attachment points of the fabric. When the fine-cover is removed, the perimeter tension decreases, which stiffens the fabric attachments, buffering energy deformation. Although this method has not been used in clothing or wearable devices previously, it is defined in laboratory systems for model systems (Wright, J. R., et al., 2010, 15.) A separate piece of material configured to fit on the fine-cover is used to seal it after use.

According to one embodiment of the present invention, there is provided another fine-covering system for a respirator mask that a) intercepts respiratory pathogens with a fabric material to which pathogens adhere, that prevents retransmission by b) positioning the fabric material in component perimeters, and c) arranging the components so their removal does not cause the intercepted pathogens from dislodging from the fabric material. In one embodiment there is at least a first component and a second component configured side by side, and the first component has a first longitudinal perimeter in an adjacent or conjoint relationship with a first longitudinal perimeter of the second component, and the first component's first longitudinal perimeter fits around a rod or pin which enables the first component to rotate over the second component. In one embodiment, the first component comprises a rigid support on at least one longitudinal perimeter, where an attachment on the rigid support connects the first component to the second component, the attachment enabling the first component to rotate over the top of the second component.

In one embodiment, the first component is attached by one or a plurality of hinges to the second component, such that the first component can fold over the top of the second component. In one embodiment there is a third component, and the different components are separated by creases, and the second component has at least one edge next to the third component and at least one edge next to the first component, and the second component folds over the third component like an accordion, and the first component rests on top.

In one embodiment the first component and the second component surround the third component, and the first component folds across the second component and the third component. In another preferred embodiment the fabric material includes parts that reflect energy away from the face mask, such as metallic material or mylar. In another particularly preferred embodiment a fabric underlayment reflective surface is used, such as vacuum aluminized paper, a thin, uniform, reflective material in which 0.02 to 0.04 microns of aluminum film are deposited on a substrate. In a preferred embodiment the fabric material includes material that is microporous and hydrophobic. In a preferred embodiment the fabric elements display graphical shapes on their surfaces that reduce the apparent bulkiness of face mask, by directing observer's eye gaze movements in patterns habitually used when looking at an attractive face without a mask. In another embodiment the fabric material comprises fibers treated with one or more anti-pathogen agents, in an amount that is effective to substantially reduce the survival or activity of targeted pathogens. In one embodiment, the fibers are treated with at least one carboxylic acid selected from the group consisting of oxyalic, ascorbic, trichloroacetic, trifluoroacetic, dichloroacetic, chloroacetic, benzoic, methanoic, ethanoic, methoxyethanoic, cxyanoethanoic, nitroethanoic, fluoroethanoic, chloroethanoic, bromoethanoic, trichloroethanoic, dichloroethanoic, and chloroethanic acids. In one embodiment the fibers are treated with at least one antiviral agent from the group consisting of proteolytic enzymes, surfactins, aminocellulose polymers, undecylenic acids, rhamnolipids, sophorolipids, glycopeptide derivatives, peroxides, chloroform extracts, cleavable surfactants, biopolymer matrices, boronic acids, siloxanes, scleroglucan, locust bean gum, tamarind gum, hydroxyethyl cellulose, sulfonates, sodium xylene sulfonate, sulfonic acid derivatives, sulfate moieties, Titanium dioxide nanoparticles, zinc oxide nanoparticles, thiazole dyes, phosphonic nucleosides, triazine derivatives, and silver inorganic materials. In one embodiment, a biosensor is incorporated in the fabric material, aligned with an energy source and detector that transmits a signal when a particular pathogen is detected.

According to another embodiment, there is provided a method of measuring the airborne pathogen levels in an environment. In one embodiment, the method comprises providing a fine-cover to be used with a pathogen measuring system according to the present invention. The measuring system rinses fine-covers in a liquid phase media followed by pathogen filtration and concentration, and the resulting extraction, alone or pooled with other fine-cover extractions, is tested using PCR or other molecular detection method. Those versed in the art of prokaryote, protist, and viral detection methods will be familiar with the various tools available.

In another embodiment of the present invention, there is presented a method of preventing deformation energy from propagating across fine-cover surfaces that have absorbed or adsorbed pathogens, to eliminate pathogen shedding. The method employs fabric panels in topological arrangements. One or more panels are positioned over a respirator mask. The panels can be folded into a sealed unit without causing energy flux in the fine-cover. The method comprises a) providing a fine-cover for a respirator mask according to the present invention, b) wearing the fine-cover, and c) removing the fine-cover.

### BRIEF DESCRIPTION OF THE DRAWINGS

These and other features, aspects and advantages of the present invention will become better understood with regard to the following description, appended claims, and accompanying figures, not limited by the figures, in which like references may indicate similar elements and in which:

FIG. 1 is a frontal perspective view of a respirator mask;

FIG. 2 is a front lateral perspective view of one embodiment of a fine-cover according to the present invention;

FIG. 3a-f illustrate one embodiment of a fine-cover according to the present invention, 3a showing a perspective view, 3b showing the removal cover used to remove the 3a fine-cover, 3c and 3d are close up views of auxetic structures on a perimeter structure, 3e and 3f show perspective views of the 3a fine-cover, 3e containing a longitudinal fold, and 3f a horizontal fold;

FIG. 4a-h are samples of a sequence of front lateral perspective views of 4b the fine-cover shown in FIG. 2 being removed from 4a the respirator face mask shown in FIG. 1, 4c-e folding the fine-cover inwards to avoid surface flux, 4f forming a sealed unit, 4g-h placing in a disposal bag;

FIG. 5a is a diagrammatic representation of one embodiment of a fine-cover according to the present invention;

FIG. 5b is front lateral perspective view of the fine-cover shown in FIG. 5a;

FIG. 6a is a diagrammatic representation of one embodiment of a fine-cover according to the present invention, showing the basic design;

FIG. 6b shows the folded fine-cover shown in FIG. 6a;

FIG. 6c is a front lateral perspective view of the fine-cover shown in FIG. 6a;

FIG. 7a is a diagrammatic representation of one embodiment of a fine-cover according to the present invention, showing the basic design;

FIG. 7b shows the folded fine-cover shown in FIG. 7a;

FIG. 7c is a front lateral perspective view of the fine-cover shown in FIG. 7a;

FIG. 8a is a diagrammatic representation of one embodiment of a fine-cover according to the prese4nt invention, showing the basic design;

FIG. 8b shows the folded fine-cover shown in FIG. 8a;

FIG. 8c is a front lateral perspective view of the fine-cover shown in FIG. 8a;

FIG. 9a represents one embodiment of a fine-cover according to the present invention, showing the basic design and the folded fine-cover;

FIG. 9b illustrates different designs of the inner component of FIG. 9a;

FIG. 9c illustrates a front lateral perspective view of the fine-cover shown in FIG. 9a;

FIG. 10a-b are frontal perspective views of one embodiment of a fine-cover according to the present invention, with FIG. 10a showing the reflective base layer, and FIG. 10b showing the top layer;

FIG. 11 illustrates frontal perspectives of a person's face displaying aggregated eye gaze movements on it, with and without a face mask and a fine-cover;

FIG. 12 is a front lateral view of the embodiment shown in FIG. 5a and FIG. 5b being worn by a wearer;

FIG. 13 is a flow chart of the post-use measurement system for the fine-covers.

### DETAILED DESCRIPTION

According to the present invention, there is provided a fine-cover for a respirator mask, for decreasing the transmission of one or more pathogens adhering to the fine-cover, extending the usage of the respirator mask worn underneath the fine-cover, reducing the discomfort of wearing the respirator mask, improving the confidence of a wearer of the respirator mask, and providing an airborne pathogen detector with the fine-cover closed unit. The fine-cover comprises material to which pathogens adhere, and has a compound structure so that pathogens do not disjoin when the fine-cover is removed from the face mask, and further contracts as a closed unit to seal the fine-cover surfaces when removed. In one embodiment, the fine-cover displays imagery that directs an observer's gaze to follow patterns similar to the habitual eye movement patterns looking at an unmasked face. In one embodiment, the fine-cover material contains agents that inactivate pathogens, thereby rendering the infectious particles non-infectious. In one further embodiment the removed, sealed fine-cover closed unit is placed in a bag to safely store it. According to another embodiment of the present invention, there is provided a method for measuring the airborne pathogen levels in an environment. In one embodiment, the method comprises rinsing a used fine-cover, precipitating with filter media, concentrating residue, and testing in PCR assay or other available microbial detection method. According to another embodiment of the present invention, there is provided a method for decreasing the transmission of one or more pathogens adhering to a fine-cover of a respirator mask, extending the usage time of the respirator mask worn underneath the fine-cover, reducing the discomfort of wearing the respirator mask, and improving confidence of a wearer of the respirator mask. The fine-cover and method will now be disclosed in greater detail.

As used herein, the term “fine-cover” means a cover made of material that is thin, light-weight, breathable, and microporous. All dimensions, angles, and shapes specified in this disclosure are by way of example of one or more than one embodiment only and are not intended to be limiting.

As used herein, “pathogen” comprises bacteria, fungi and viruses, or other microorganisms that cause human disease.

As used herein, “component” means an area of cover material that is defined by a perimeter that borders the cover material.

As used herein, “center-front area” means the front-facing geometric center of a face mask, located over the wearer's nose and mouth.

As used herein “outermost component” means a component that is more distant from the mask center-front area, on at least one side of the horizontal plane, than other components on that side and “inner component” means a component that is closer to the mask center-front area than an outermost component.

As used herein, “outer edge” means a component perimeter furthest from the mask center-front area, and “inner edge” means a component perimeter closest to the mask center-front area.

As used herein, “accordion” means that pleats are used so that fold lines form pleat mountains or valleys between components when contracted, and the fine cover material having shape retention an intended pleat shape can be preferably provided; “top component” refers to the side of the pleat mountain that, when folded, is on top of the other side of the same pleat mountain, and “bottom component” refers to the side of a pleat mountain that, when folded, is below the other side of the pleat mountain; “under-all component” refers to the component that all other pleat mountains fold over.

As used herein, “energy deformation” refers to all types of physical deformation generally, unless indicated otherwise. Deformation is defined as the dislocation of points on a surface from their position in a stable physical state. The root cause of “energy deformation” is that physical vibrations caused by the release of elastic bands holding a face mask to the user's head propagate across the face mask surface. This energy propagation is also called “surface flux”. Microscopic buckling distortion is characterized by a microscopic wavy undulating surface. Such microscopic buckling distortion may lead to the separation of microbes adhered to the surface (Vella, D., 2019, 16.)

As used herein, “spatial gap” refers to a space between two closely spaced objects, such as a gap between a fine cover and a respirator mask.

As used herein, “polluted” refers to contamination and physical fouling of a respirator mask.

As used herein, “topological pattern” is a composition of components with self-folding motion inherent in creases or boundaries between edges and vertices.

As used herein, “perimeter” is the outer portion or edge of components, the periphery that outlines component shapes, so as to make a contour around them.

As used herein, “respirator mask” refers to a “personal protective device that is worn on the face, covers at least the nose and mouth, and is used to reduce the wearer's risk of inhaling hazardous airborne particles,” according to the Centers for Disease Control. Respirators “remove contaminants from the air,” and “are also commonly referred to as “N95s” (CDC, 2018, 17.) Respirator masks use nonwoven, melt blown fiber webs rather than conventional textiles. These fiber webs have voids larger than 0.1 μm diameter. Since the late 1970s, Respirator mask manufacturing uses electrostatic charging of fibers through field and induction to filter >95% of particles with 0.1 μm diameter (U.S. Pat. 4,375,718 to Wadsworth & Hersh, P5.) Aerosol microbes suspended in aqueous droplets adhere to the respirator mask surface or subsurface, instead of penetrating. Electrostatic charges trap microbes in liquid spheres. Shear forces, induced by deformation energy rippling across surfaces during mask removal, exponentially increases disaggregation of microbial particles (Bos, R. et al., 1999, 17.)

As used herein, an “auxetic structure” is a combination of materials, such as a cylindrical perimeter and fabric connectors, that together have a negative Poisson's ratio. Poisson's ratio is the contraction or transverse strain (normal to applied load) divided by the extension or axial strain (in the applied load's direction.) If negative, when the perimeter is compressed (or stretched) in one direction, such as when released from (or extended by) attachments, the fabric connectors become stretched (or relax). This prevents fabric from shaking when a fine-cover is removed. The auxetic configuration provides energy dissipation as deformation energy is dissipated through the increased strain energy of the connecting fibers.

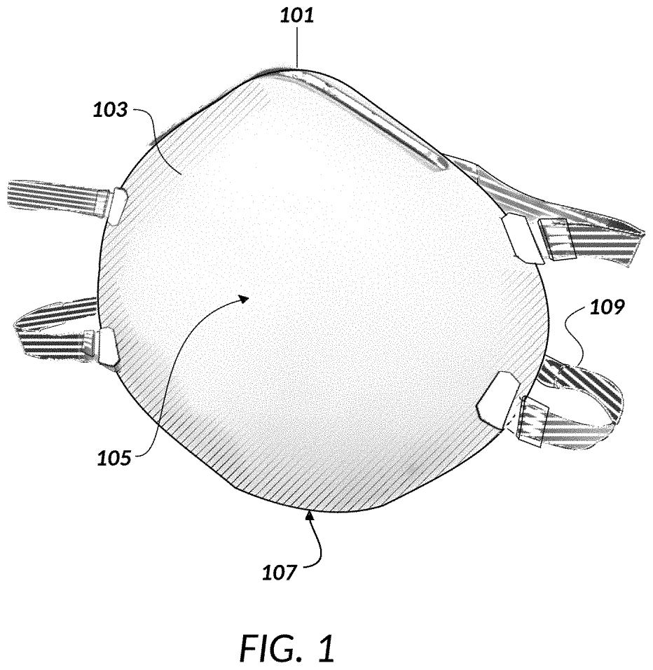

FIG. 1 displays a frontal perspective view of one type of respirator mask 101 (of the N95 type). As can be seen, the respirator mask 101 comprises a body 103 for covering the mouth and nose of a human wearer, and extends to a considerable degree out from the face of the wearer, forming a convex shape towards the center-front area 105 of the body 103. The body 103 further comprises a perimeter 107 surrounding the body. The body 103 further comprises one or more extensions 109 joined to the body 103 for securing the respirator mask 101 to the head of the wearer.

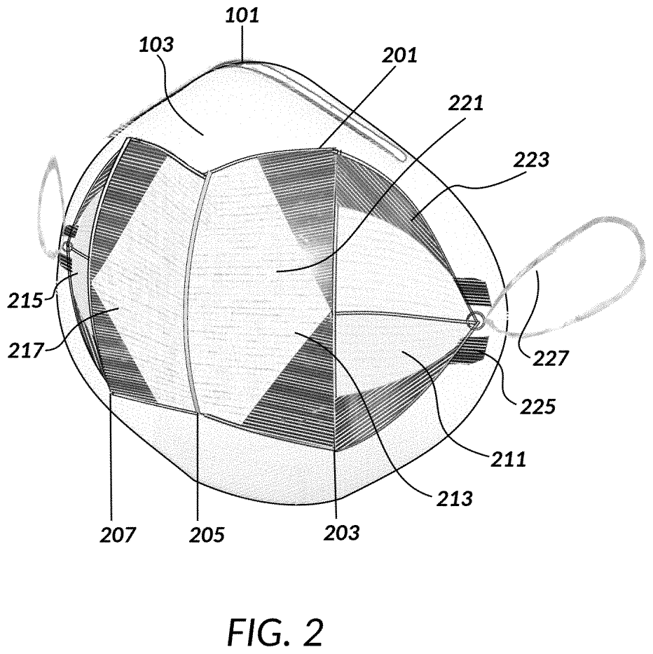

According to the present invention, there is provided a fine cover for decreasing the transmission of one or more than one human pathogen intercepted by the fine cover, protecting the respirator mask worn underneath, improving the comfort and appearance of the wearer, and permitting safe doffing and storage of the used fine cover. Referring now to FIG. 2, the respirator mask 101 comprises a body 103 over which a fine cover 201 is positioned. The shape of the fine cover 201 can be any suitable shape for the purpose intended, as will be understood by those with skill in the art with reference to this disclosure. In a preferred embodiment, as shown in FIG. 2, the topological pattern of the fine cover is governed by right 203, center 205, and left 207 fold edges (directions looking at the fine cover from the front.) In topology, the end result of folding a topological pattern is sometimes called the surviving minimum, which is equivalent to a closed unit. Energy deformation is minimized as embodiments have fold angles in the closed unit with creases or hinges that closely correspond to fold angles that the folding follows without creases or hinges. This invention has crease stiffness profiles that can be carelessly actuated without increasing energy deformation.

As seen in FIG. 2, the topological pattern of the fine cover 201 is particularly advantageous because is isolates any potential deformation energy in outer components 211 and 215, so that right outer component 211 does not propagate deformation energy to a right inner component 213, and left outer component 215 does not propagate deformation energy to a left inner component 217. The fine cover 201 contains lightweight, breathable, non-stretchable material 221, that does not cause a greenhouse-effect to the wearer, preferably modal cellulose, micromodal, silk, or linen. Mesh, tricot, and other sheer fabric may be used. The fine cover 201 also contains a thin, uniform, reflective layer 223 such as vacuum aluminized paper, usually under a fabric surface, to prevent heat build-up. Velcro attachments 225 are attached, to facilitate sealing the folded-up fine cover after use. Extensions 227 attach the fine cover 201 to the wearer.

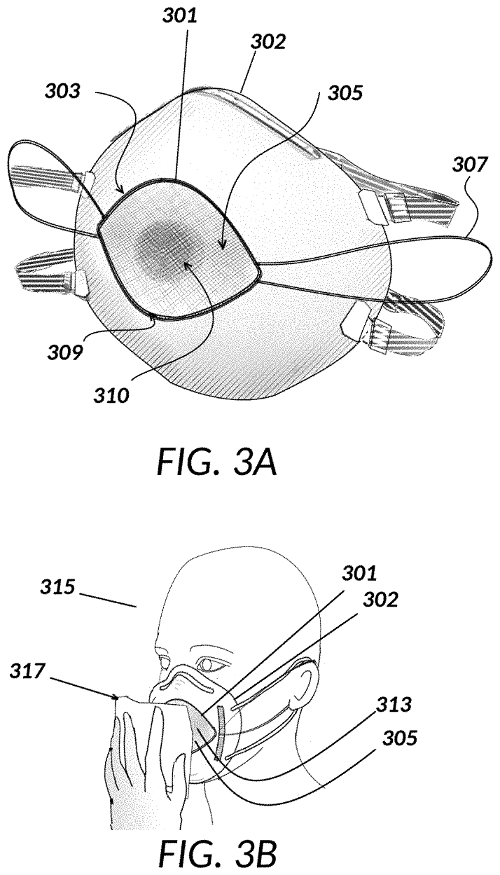

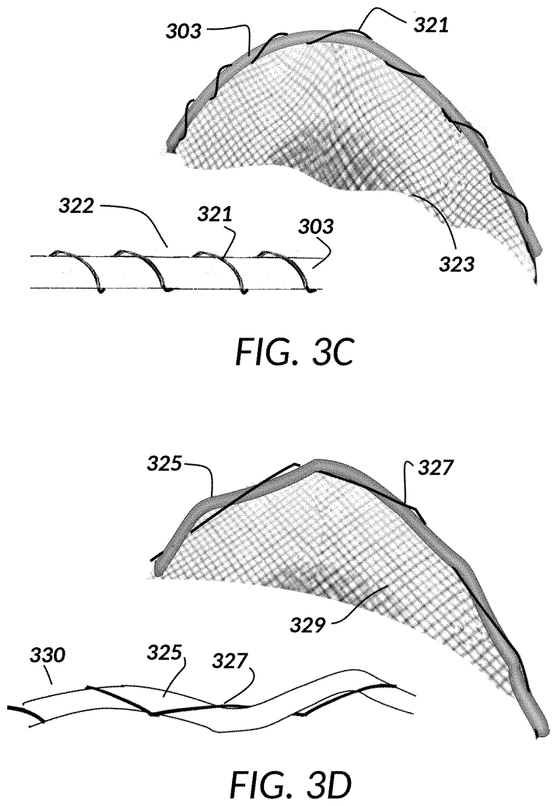

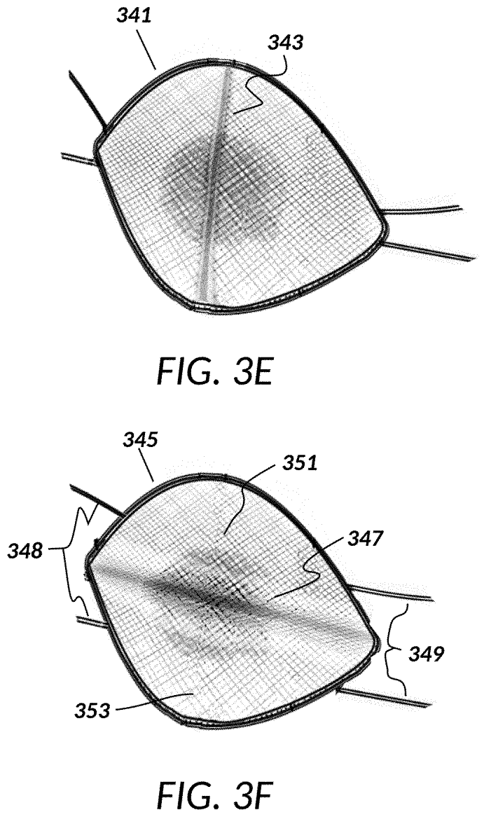

FIG. 3A illustrates a fine-cover 301 in a further embodiment comprises one or more components 303 with lightweight, breathable material 305 that covers primarily the nose and mouth area of the wearer of a respirator mask 302. The small fine cover fabric material 305 is attached to semi-rigid structures 309, which seal the small fine cover fabric material 305 that is over an air exchange mechanism located on the respirator mask 302 beneath the shaded area 310. An interspace may exist between small fine cover fabric material 305 and the underlying face mask 302 but semi-rigid structures 309 ensure the interspace area is sealed, and thereby wearing small fine cover 301 according to the present invention, when compared with wearing only a respirator mask with an air exchange mechanism, decreases egress of airborne infectious particles outward from the air exchange mechanism. The small fine cover 301 is held in place by extensions 307.

FIG. 3B illustrates an embodiment 315 in which the small fine cover 301 is worn over a respirator-mask 302, wherein the fine-cover 301 is being prepared for removal. As the small fine cover 301 is only one component, a flexible cover 317 is lifted onto the fine cover 301 to seal the outer surface 313 of the fabric material 305.

FIG. 3C illustrates a detail of the small fine cover in FIG. 3A, to show its auxetic structure. The perimeter structure 303 axial strain, when the small fine cover is worn, is positive, being stretched across the surface. At the same time the fabric's connecting fiber 321 strain is transverse and negative, because the tensile modulus of perimeter structure is higher than that of the connecting fiber, and because of how the fiber wraps around the perimeter. While the stretched perimeter seals the area under the fabric, the fabric 323 is not stretched tight, but is to some degree looser. 322 shows an expanded view of the connecting fiber 321 and perimeter structure 303 helical arrangement, when the fine cover is worn.

FIG. 3D illustrates the same detail as FIG. 3C during the small fine cover's removal. The auxetic properties now invert: the perimeter structure 325 axial strain is reduced, being released from its stretched state. At the same time, the fabric's connecting fiber 327 transverse strain is increased. The tensile modulus of the connecting fiber 327 is forced higher, in part due to the perimeter structure 325 stiffness. As the perimeter structure 325 is relaxed during removal, this tightens the fabric 329, so that its surface does not shake. 330 shows an expanded view of the connecting fiber 327 and perimeter structure 325 helical arrangement, as the fine cover is removed. FIG. 3E illustrates the small fine cover in FIG. 3A with a longitudinal demarcation line 343 around which the small fine cover 341 folds to close. Alternatively FIG. 3F illustrates the small fine cover in FIG. 3A with horizontal demarcation 347 around which the small fine cover 345 folds or rolls to close. In FIG. 3F when attachments 348 and 349 are released, the motion results in the upper 351 and lower 353 halves of the fine cover 345 closing automatically.

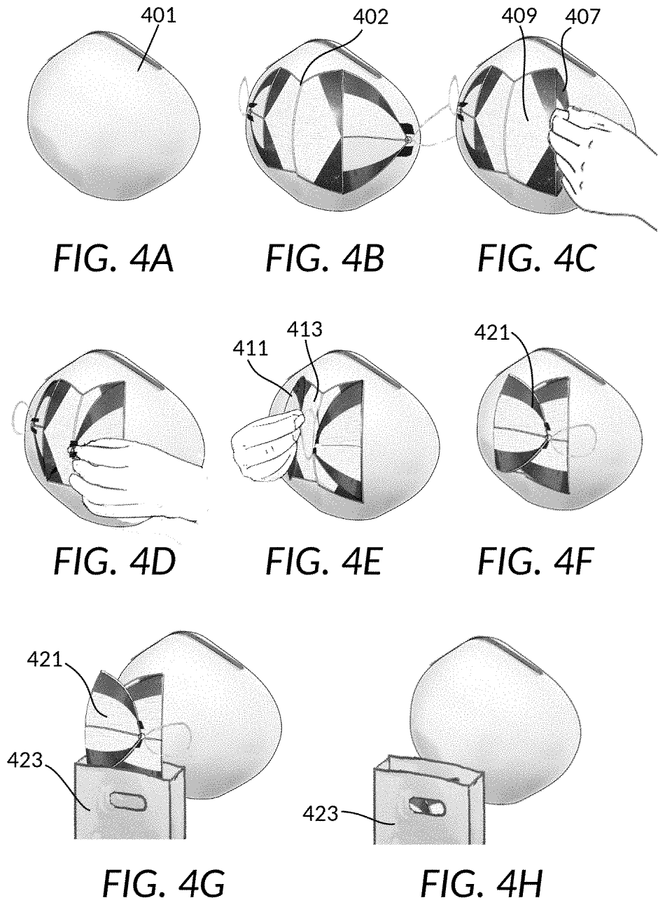

FIG. 4A-H illustrate perspective views of the removal of the fine cover shown in FIG. 2. FIG. 4A illustrates a respirator mask 401. FIG. 4B illustrates a fine cover 402 positioned over the respirator mask 401, as worn by a user. FIG. 4C and FIG. 4D illustrate the user's hand pivoting a far right component 407 of the fine cover over the top of the near right component 409 of the fine cover. FIG. 4E illustrates the user's hand pivoting a far left component 411 of the fine cover over the top of the near left component 413 of the fine cover. FIG. 4F illustrates the fine cover closed unit 421, with the surfaces of all components sealed, held in place by the velcro strips that are no longer visible. FIG. 4G illustrates the fine cover closed unit 421 as it fits in a dedicated disposal/reuse bag 423. FIG. 411 illustrates the dedicated disposal/reuse bag 423 containing the used fine cover.

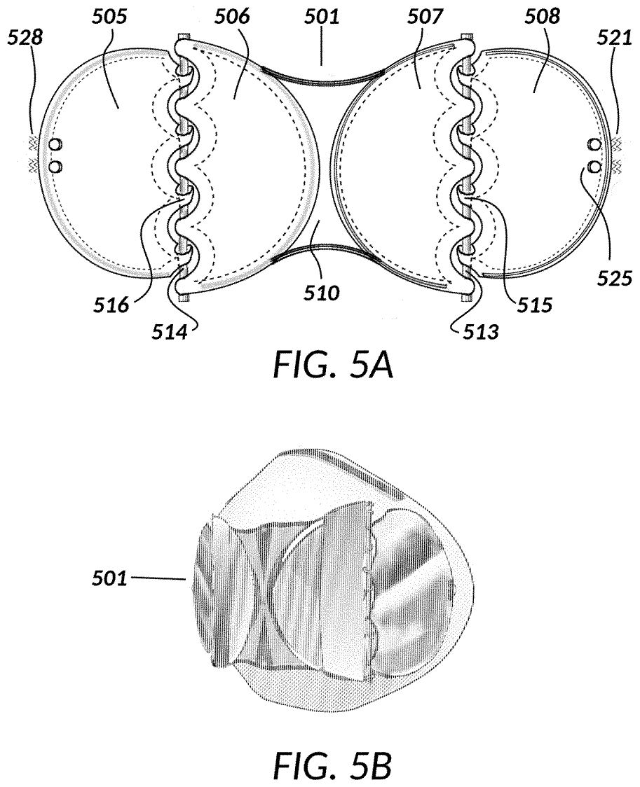

In a preferred embodiment, as illustrated in FIG. 5A, fine cover 501 can comprise a plurality of components, far left component 505, near left component 506, near right component 507, and far right component 508, with stretch panel 510 in a centroid position. The plurality of components 505, 506, 507, and 508 can comprise a variety of shapes, sizes, colors, and combinations thereof so long as far left component 505 and far right component 508 substantially cover near left component 506 and near right component 507, respectively, when far left component 505 and far right component 508 are folded closed. The plurality of components 505, 506, 507, and 508 can comprise a variety of materials such as, for example, modal cellulose, micromodal, silk, linen, mesh, tricot, or other sheer fabric.

Fulcrum member 513 can be a post, an axle, a bar, or other suitable support, in a best mode teflon coated. By reason of connectors 515, far right component 508 is attached to fulcrum member 513. When the fine cover 501 is worn, far right component 508 is flattened, thereby being urged against fulcrum member 513 to be in an open relation as illustrated in FIG. 5A. Far right component 508 may be manually grasped and conveniently lifted. By such action this swings component 508 relative to an integral hinge means formed at the confluence of fulcrum member 513 and connectors 515, and consequently far right component 508 may readily cover near right component 507 and thereafter adequately clasp thereby against the attachment mechanism 521. Attachment mechanism 521 effectively but removably sustains the closure of the right side of fine cover 501, forming an integral seal means whereby the outer surfaces of components 507 and 508 are held against each other. Posts 525 are used to attach extension straps or lines that hold the fine cover 501 in position.

It is apparent that the process forming the integral hinge means on the right side of the fine cover 501, as provided for in the confluence of fulcrum member 513 and connectors 515, may be used to rotate far left component 505 up, over, and to cover near left component 506, using fulcrum member 514 and connectors 516 to form an integral hinge means on the left side of the fine cover 501. It is apparent that the process forming integral seal means on the right side of the fine cover 501, as provided for by attachment mechanism 521, may be used to form integral seal means on the left side of the fine cover 501, by attachment mechanism 528 holding the outer surfaces of components 505 and 506 against each other.

FIG. 5B depicts fine cover 501 with imagery on component and panel surfaces. As mentioned above, this imagery helps control the eye gaze pattern of observers, producing a gaze pattern similar to looking at an unmasked face.

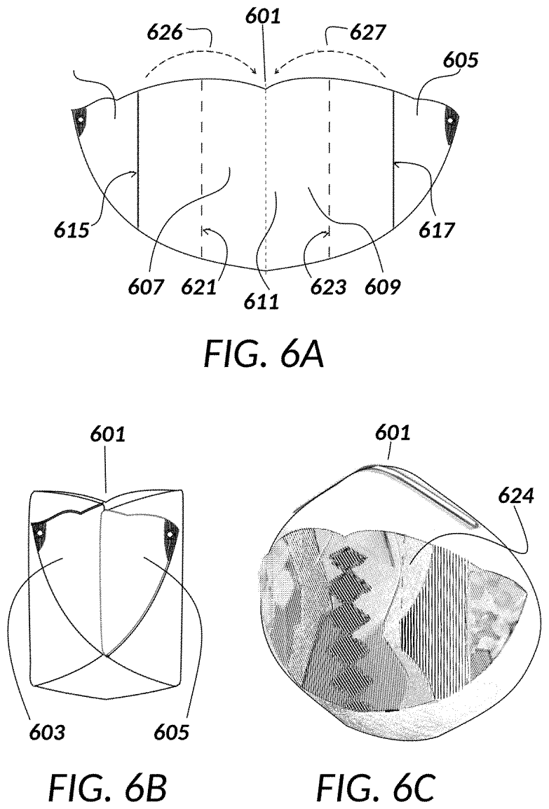

FIG. 6A is a diagrammatic representation of another embodiment of a fine cover 601. Fine cover 601 comprises above-fold components 603 and 605, under-fold components 607 and 609, and underlay component 611. Fine cover 601 displays five components, but it may, for example, have three, four, six, seven, or more components. Upon closing, above-fold component 603 folds along fold line 615 to form a peak, and above-fold component 605 folds along fold line 617 to form a peak. Continuing the closure, under-fold component 607 folds along fold line 621 to form a trough, and under-fold component 609 folds along fold line 623 to form a trough. The closure continues by placing fold line 615 on center line 625, in the motion illustrated by arrow 626, and placing fold line 617 on center-line 625, in the motion illustrated by arrow 627.

FIG. 6B is a diagrammatic representation of fine cover 601 when closed. Above-fold components 603 and 605 are visible, as they sit above the rest of the mask. The size of the closed fine mask in FIG. 6B allows it to fit in a disposal/reuse bag.

FIG. 6A depicts fine cover 601 with imagery 624 on component and panel surfaces. As mentioned above, this imagery helps control the eye gaze pattern of observers, producing a gaze pattern similar to looking at an unmasked face.

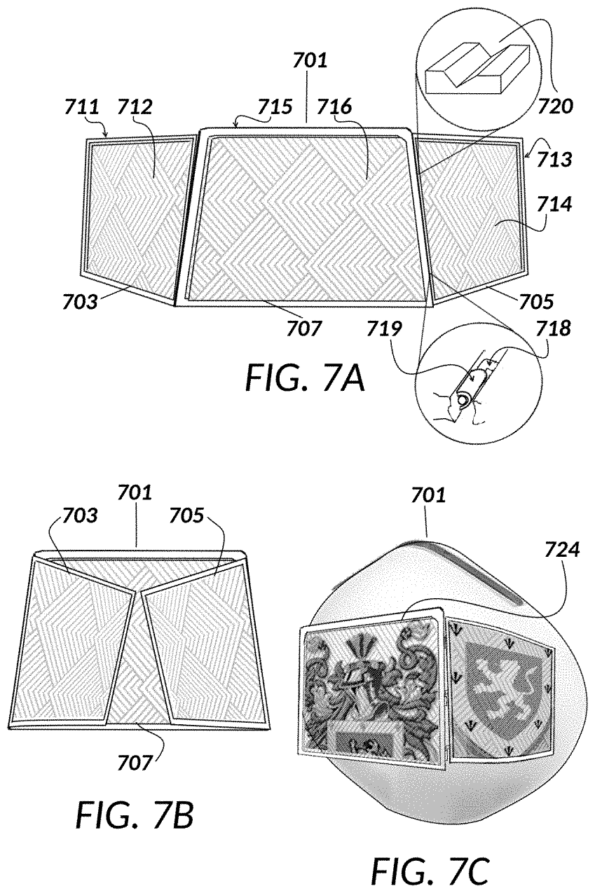

FIG. 7A is a diagrammatic representation of another embodiment of a fine cover 701. Fine cover 701 comprises side components 703 and 705 and center component 707. Component 703 is configured with a frame 711 that holds fabric material 712. Component 705 is configured with a frame 713 that holds fabric material 714. Component 707 is configured with a frame 715 that surrounds fabric material 716 held within it. Frame 715 includes hinge parts, each hinge part mating with one of each of one or a plurality of hinge parts included in frame 711 and 713 to form a pair of hinge parts. Each pair of hinge parts may comprise a pintle 718 and a gudgeon 719. When components 703 and 705 are lifted by the user, they rotate across the top of component 707.

Alternatively, the part of frame 715 which joins with frame 711 may be fused to or combined with frame 711, and on this surface may have a reduced thickness band along its length, as illustrated in expanded diagram 720, and the part of frame 715 which joins with frame 713 may be fused to or combined with frame 713, and on this surface may have a reduced thickness band along its length, as illustrated in 720. The reduced thickness band 720 may be called a “crease pattern.” The crease pattern 720 induces side components 703 and 705 to rotate over center component 707 when lifted by a user. Frames may comprise rigid or semi-rigid material.

FIG. 7B is a diagrammatic representation of fine cover 701 when closed. Side components 703 and 705 are visible, as they sit above center component 707. The size of the closed fine mask in FIG. 7B allows it to fit in a disposal/reuse bag.

FIG. 7C depicts fine cover 701 with imagery 724 on component surfaces. As mentioned above, this imagery helps control the eye gaze pattern of observers, producing a gaze pattern similar to looking at an unmasked face.

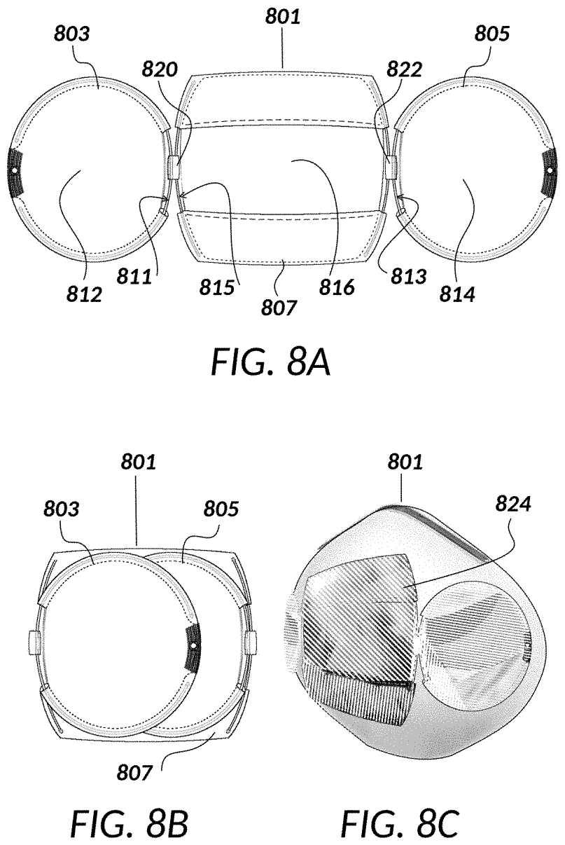

FIG. 8A is a diagrammatic representation of another embodiment of a fine cover 801. Fine cover 801 comprises side components 803 and 805 and center component 807. Component 803 is configured with a frame 811 that holds fabric material 812. Component 805 is configured with a frame 813 that holds fabric material 814. Component 807 is configured with a frame 815 that surrounds fabric material 816 held within it. A hinge 820 connects frame 811 and frame 815. A hinge 822 connects frame 813 and frame 815. When components 803 and 805 are lifted by the user, they rotate across the top of component 807.

Fine cover 801 displays side components 803 and 805, each in a round configuration, but it may, for example, be in an ovoid, polygonal, substantially circular, closed curvilinear geometric, or other shape configuration.

FIG. 8B is a diagrammatic representation of fine cover 801 when closed. Side components 803 and 805 are visible, as they sit above center component 807. The size of the closed fine mask in FIG. 8b allows it to fit in a disposal/reuse bag.

FIG. 8C depicts fine cover 801 with imagery 824 on component surfaces. As mentioned above, this imagery helps control the eye gaze pattern of observers, producing a gaze pattern similar to looking at an unmasked face.

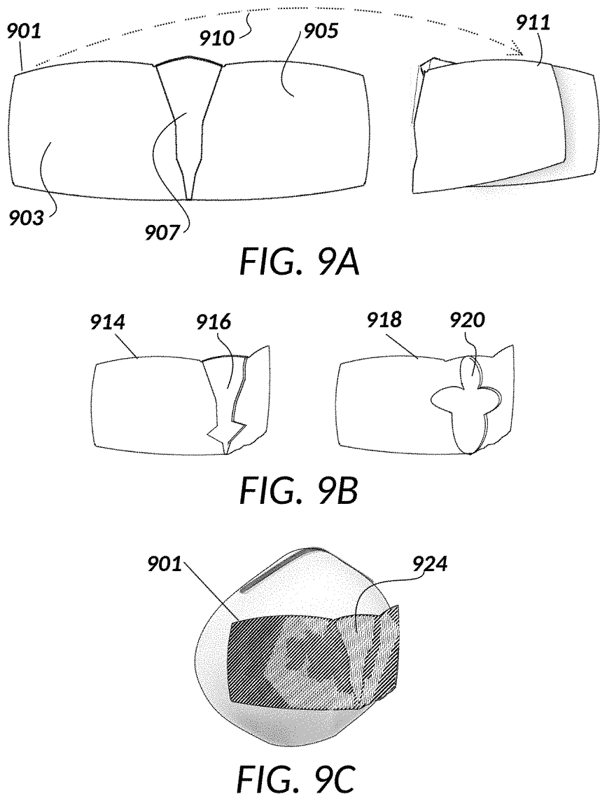

FIG. 9A is a diagrammatic representation of another embodiment of a fine cover 901. Fine cover 901 comprises side components 903 and 905 and center component 907. Side component 903 folds over both center component 907 and side component 905. The motion of this folding is shown with arrow 910, and the fine cover 901 closure is illustrated in 911. Alternatively, side component 905 folds over both center component 907 and side component 903.

FIG. 9B is a diagrammatic representation of the fine cover embodiment in FIG. 9A, but with different center component shapes. Fine cover 914 has the same structure as fine cover 901, with a different shape of center component 916. Fine cover 918 has the same structure as fine cover 901, with a different shape of center component 920.

FIG. 9C depicts fine cover 901 with imagery 924 on component surfaces. As mentioned above, this imagery helps control the eye gaze pattern of observers, producing a gaze pattern similar to looking at an unmasked face.

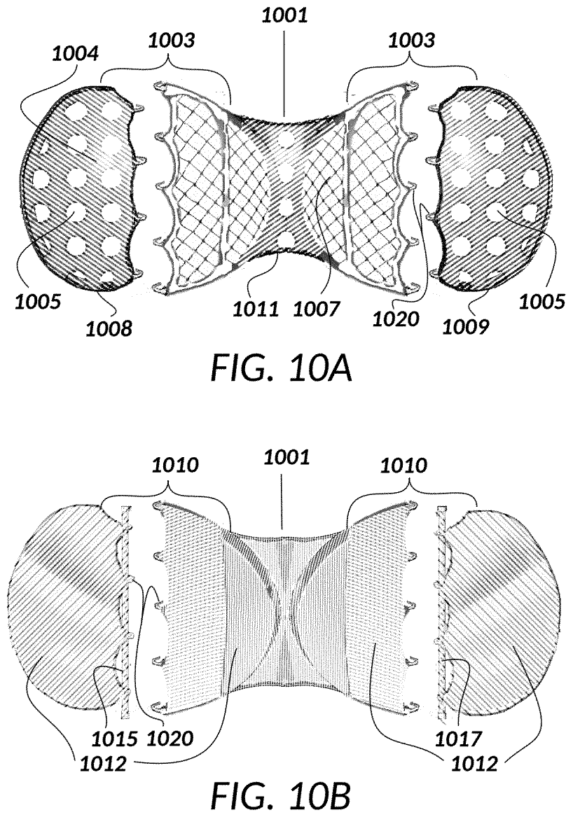

FIG. 10A and FIG. 10B are frontal perspective views of one embodiment of a fine cover 1001 according to the present invention, with FIG. 10A showing the reflective base layer 1003, and FIG. 10B showing the top layer 1010. In FIG. 10A, the reflective base layer 1003 includes a film layer 1004 having at least one reflective side. The film layer 1004 is achieved with a metallised film or other material. In this embodiment an aluminum layer deposited on a surface has a thickness of 200 nanometers or less. A protective coating of 1 micron or less thickness may be applied to prevent oxidation of the aluminum layer.

Reflective base layer 1003 outer components 1008 and 1009 include empty spaces 1005 to preserve air flow through the fine cover 1001. Reflective base layer 1003 inner component 1011 has a net-like web 1007, that may be configured of reflective material. Alternatively, cooling of the underlying face mask may be obtained by using a base layer with one or more wavelength-selective radiative cooling materials, comprising a selectively emissive layer, in particular, emitting infrared radiation.

FIG. 10B illustrates a top layer 1010 of fine cover 1001. In this embodiment top layer 1010 goes over FIG. 10A reflective base layer 1003. A sufficient surface area of the top layer 1010 fabric material 1012 provides a fabric material function, which is to adsorb, absorb, and/or otherwise enable pathogenic microbes to adhere to the fabric material, and to inactivate a significant fraction of the pathogenic microbes. The top layer 1010 fabric material 1012 may have properties such as air permeability and moisture vapor transfer, and contain anti-pathogen agents.

Both top layer 1010 and reflective base layer 1003 attach to poles 1015 and 1017 with attachments 1020 in a manner that permits outer components to rotate without friction over inner components.

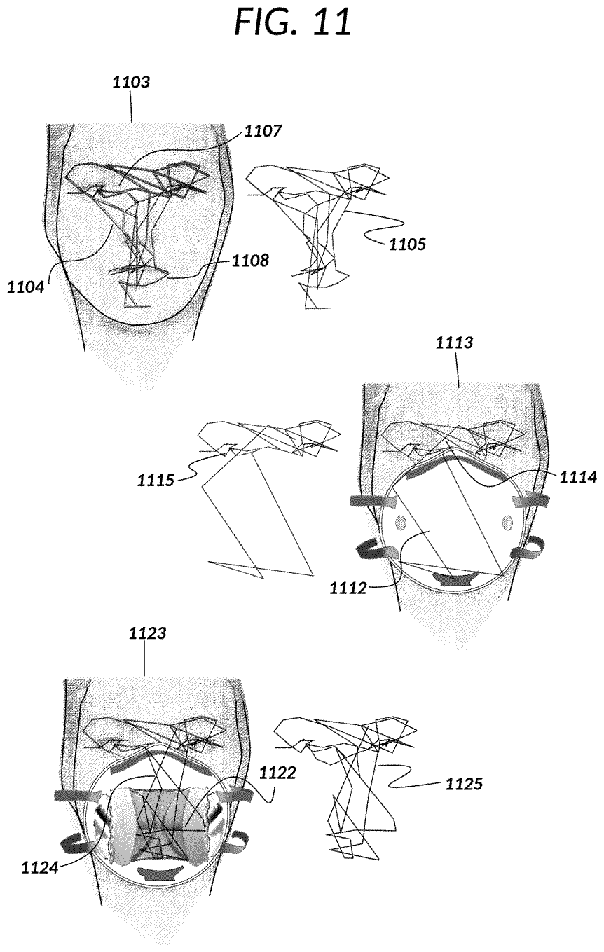

FIG. 11 shows frontal perspectives of a person's face displaying aggregated eye gaze movements on it, with and without a face mask and a fine cover. The eye gaze movement patterns are isolated next to each face. 1103 shows a frontal perspective of a person's face with aggregated eye gaze pattern 1104 of observers of that person's face, collected by researchers using eye tracking cameras.

The lines show the motion of the observer's gaze across the face, which are isolated in 1105. Notice the gaze pattern 1104 shifts between eyes 1107 and mouth 1108, forming a T shape, visible in 1105. 1113 shows a frontal perspective of a person wearing a face mask 1112, with aggregated eye gaze pattern 1114 of observers of that person's face and face mask. This pattern is isolated in 1115. Notice the T shape is less evident. In so far as people look at faces, particularly female faces, using the T pattern of gaze, it forms a standard habit that aids in communication. The gaze pattern is missing in 1113. 1123 shows a frontal perspective of a person wearing a face mask with a fine cover of this invention, with aggregated eye gaze pattern 1124 of observers of that person's face, mask, and fine cover. This pattern is isolated in 1125. Notice the T shape pattern of gaze reappears, because observers have been guided by fine cover imagery. Although different fine covers may have different imagery and designs, they all direct gaze patterns down the center of the face.

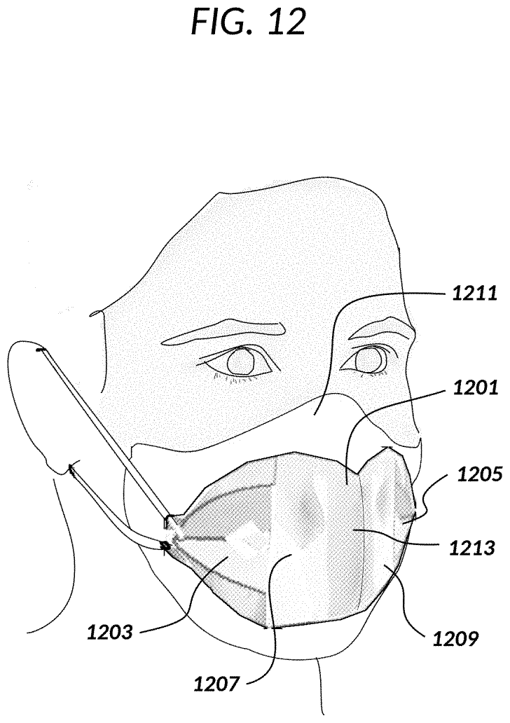

FIG. 12 is a frontal perspective view of the embodiment of the fine cover shown in FIG. 2 being worn by a wearer. As can be seen, a first advantage to the fine cover 1201 according to the present invention is reducing the aggregation of pathogenic microbes on the surface of the respirator mask 1211 by the pathogenic microbes adherence to the material 1213 in fine cover 1201, and preventing the adhered pathogenic microbes from dislodging during fine cover doffing by the outer components 1203 and 1205 folding over top of inner components 1207 and 1209 without causing energy deformations, and thereby effectively sealing the inner components 1207 and 1209. The fine cover absorbs and/or adsorbs pathogenic microbes which do not dislodge when the fine cover is doffed, but are instead sealed. Then the fine cover may be placed in a dedicated disposal/reuse bag. Then the fine cover may be cleaned, tested, reused, or disposed. The fine cover absorbs and/or adsorbs pathogenic microbes which do not dislodge when the fine cover is doffed, but are instead sealed. Then the fine cover may be placed in a dedicated disposal/reuse bag. Then the fine cover may be cleaned, tested, reused, or disposed.

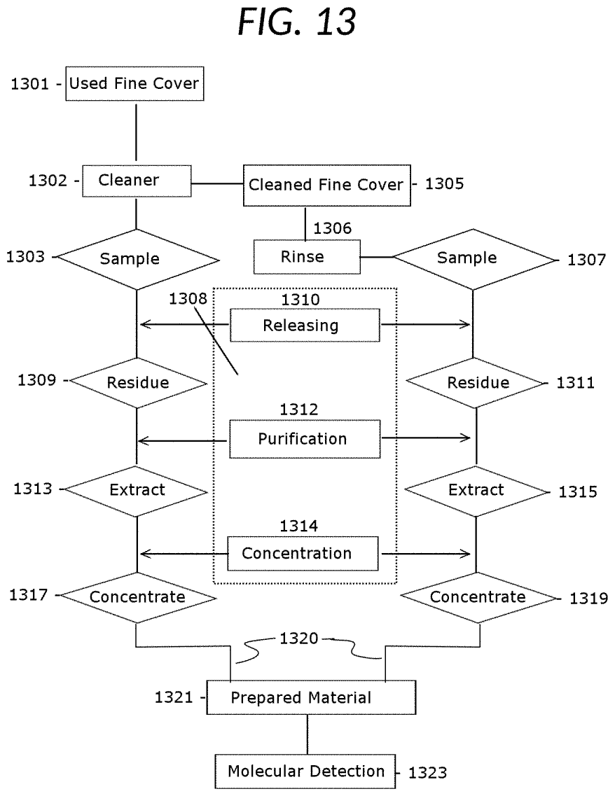

With reference to FIG. 13 a flow chart of a method for testing microbial content in a fine cover, as part of the fine cover cleaning, is illustrated. A single fine cover may be tested, or a batch process with multiple fine covers from an area may be tested. The cleaning process involves a cleaner 1302, after which one or more cleaned fine covers may be prepared for reuse 1305. A sample 1303 is extracted from the cleaner 1302. One or more cleaned fine covers 1305 may also be tested, for quality control. In this case the one or more cleaned fine covers are rinsed 1306, and a sample 1307 is extracted. Sample 1303 enters an isolating regime 1308, and sample 1307 enters the isolating regime 1308. Isolating regime 1308 proceeds to isolate prepared material 1321 and 1323. There are multiple approaches to isolating regime 1308. Molecular aggregates that include DNA or RNA are filtered using methods such as density gradient centrifugation, organic solvent extraction, and salt precipitation. Impurities may be removed by precipitation, centrifugation, and/or selectively eluted. It will be apparent to those skilled in the art that the description of the embodiment in FIG. 13 only represents one of many methods known, and is provided as an example.

For either the used fine cover sample 1303 or the cleaned fine cover sample 1307, isolating regime 1308 begins with releasing step 1310. First biological material, such as DNA, RNA, or other biological substances, is released from cells, tissue, or other substrate. This may involve one or more methods such as centrifugation, protein dissolving, disruption of cells, homogenization, and other methods known to those skilled in the art. Then it is necessary to remove impurities (such as proteins, lipids and carbohydrates) from the residue 1309 or 1311, purification step 1312. Some methods to remove impurities include density differentiation, organic-aqueous phase partitioning, selective salt precipitation, phenol extractions, binding and washing, and other methods known to those skilled in the art. The purification process may be a filtration process, including, but not limited to, electropositively charged glass wool, hollow-fibre ultrafiltration fibers, a positively charged filter media such as that made by adding silica gel to an aluminium hydroxide precipitate, magnetic beads, metal oxides, latex particles, silica-based particles or another process known to those skilled in the art. Purification can involve multiple steps, such as precipitation of crude DNA or RNA fractions followed by any one of several methods, such as adsorption on substrates, column chromatography, dissolving in a chaotropic solution, and other methods known to those skilled in the art.

The next step is concentration, 1314. Molecular material may be concentrated by one or more of the following methods, or other methods known to those skilled in the art: sodium acetate precipitation followed by ethanol wash; extraction and precipitation using phenol or acetone and/or precipitates such as PEG and NaCl or hydroxide; elutions such as nutrient broth, the addition of multivalent cations, metal salts or polymer coagulants, or skimmed-milk flocculation. Other techniques may be used, and the order of steps 1310, 1312, and 1314 may be altered or combined. For example, purification of molecular material process 1312 may involve acidic or alkaline modification of the aqueous solution of sample 1303 and/or 1307 to remove particles.

The result of concentration step 1314 of sample 1303 is collected as concentrate 1317; and/or the result of molecular concentration step 1314 of sample 1307 is collected as concentrate 1319. Concentrate 1317 or 1319 are readied for molecular detection, such as gene sequence testing. In many circumstances, concentrate 1317 or 1319 will be transported 1320 to a testing facility where amplification-competent DNA and/or RNA is prepared 1321. A molecular detection test 1323, such as a PCR test or loop-mediated isothermal amplification method, is used to determine the presence of molecular material of interest in sample 1303 and/or 1307.

The steps, processes, and methods outlined in FIG. 13 will be familiar to persons skilled in the art, which is why a fine mask of the present invention may serve as a convenient airborne pathogen detection system in medical facilities, many of which have staff and equipment capable of carrying these steps, processes, and methods to completion.

This written description uses examples to disclose the invention, including the best mode, and also to enable any person skilled in the art to practice the invention, including making and using any devices or systems and performing any incorporated methods. The present invention is not limited to the above described embodiments, and it goes without saying that various modifications can be made without departing from the scope of the invention.

Individual elements or features of a particular embodiment are generally not limited to that particular embodiment, but, where applicable, are interchangeable and can be used in a selected embodiment, even if not specifically shown or described. The same may also be varied in many ways. Such variations should not be regarded as a departure from the disclosure, and all such modifications are intended to be included within the scope of the disclosure.

1. A fine cover operatively worn to cover a facemask, comprising:
a) a body comprising one or more components, each comprising:
one or more perimeters defining the component's shape;
a material that is light-weight and breathable;
the material decreases transmission of pathogens;
b) the one or more components extending to cover a front central area of the facemask;
c) the more than one components extending to cover none, one, or more than one areas of the facemask distal from the front central area;
d) one or more attachments for securing the fine cover in place;
e) at least one of the more than one components is a first component and at least another one of the more than one components is a second component, and at least a portion of the perimeter of the first component is in an adjacent structural relationship with at least a portion of the perimeter of the second component;
pivot means in the adjacent structural relationship are operatively configured;
f) to remove the fine cover with the more than one components, at least one of the first components pivots by the pivot means over the top of at least one of the second components, and an outer surface of at least one of the second components becomes substantially covered;
g) the fine cover is effectively closed.

2. The fine cover of claim 1, wherein any one of the one or more components comprises:
a) a transverse demarcation line;
b) material having at least a first section and a second section, each of the sections positioned outboard of a transverse demarcation line;
c) the first section transversely folding along the transverse demarcation line over at least a portion of the second section;
d) the fine cover is effectively closed.

3. The fine-cover of claim 1, wherein at least one of the one or more components is not covered by another component when the fine-cover is closed;
a material shaped to cover the component not covered is provided.

4. The fine cover of claim 1, further comprising that at least one of the components, at the material surrounded by the perimeter:
at least a portion of the perimeter having a rim;
the rim having a different thickness than the component material;
the rim arranged to compress radially against the facemask, so that the area under the material within the perimeter is sealed from particle exchange with outside air.

5. The fine cover of claim 1, where to configure:
at least one of the components, at the material surrounded by the perimeter:
at least a portion of the material includes a heat reflective layer or liner adapted to prevent temperature increase of the wearer's face.

6. The fine cover according to claim 1, further comprising at mask removal:
the fine-cover is closed when at least one of the more than one components has an outer surface facing inward, and at least another one of the more than one components has an outer surface that is covered underneath,
the closed fine-cover can be placed in a bag for disposal or cleaning.

7. The fine cover according to claim 6, further comprising at the closed fine cover placed in the bag, the closed fine cover is tested to detect the presence of airborne pathogens.

8. The fine cover according to claim 1, wherein at least one of the one or more components comprise a decorative feature that attracts an observer's gaze such that the observer's light of sight with respect to the fine-cover follows a succession of points on the fine-cover, the succession of points forming a gaze pattern similar to a habitual gaze pattern of the observer looking at a face without a facemask.

9. The fine cover according to claim 1, wherein at least one of the one or more components comprises material treated with one or more anti-pathogen agents, in an amount that is effective to substantially reduce the survival or activity of targeted pathogens.

10. The fine cover according to claim 1, wherein the material is selected from the group consisting of: microfiber, cellulose fiber, modal fabric, micromodal fabric, silk, linen, mesh, tricot, soutache, cotton, hemp, synthetic fibers, and combinations thereof.

11. A method preventing the release of microbial pathogens adhering to a fine-cover worn over part of a respirator mask, comprising the steps of:
providing at least one component comprising a breathable, light-weight, fabric-like material interconnected with one or more perimeter structures, by way of one or more connecting fibers in an auxetic relationship with at least one of the perimeter structures; and
removing the fine-cover by releasing attachments that hold it in place;
in which: a) at least one of the perimeter structures extends generally longitudinally relative to an axis of one or more connecting fibers; b) at least one of the perimeter structures and at least one of the connecting fibers are in a helical configuration; c) each perimeter structure in a helical configuration with a connecting fiber has a different modulus of elasticity from the connecting fiber; d) variation in a tensile or compressive load applied to the perimeter structure upon removal of the fine-cover causes the radial position of the connecting fibers relative to their axis to vary, producing an auxetic effect that prevents the component material from shaking and releasing microbial pathogens.

12. A method for determining the presence of airborne pathogens present in an environment, comprising the steps of:
a) wearing a fine-cover over a facemask, the fine-cover comprising:
i) one or a plurality of components defined by perimeters around light-weight, breathable material to which pathogens adhere, and
ii) the plurality of components including a first and a second component in an adjacent relationship, the first component capable of pivoting over the second component, closing the fine-cover;
b) placing the closed fine-cover in a disposal bag;
c) transporting the fine-cover and disposal bag to a testing location;
d) treating the fine-cover with a substance;
e) drawing a sample from the substance;
f) condensing the sample to form a concentrate;
g) testing the concentrate in a molecular detection apparatus.
